(19) United States
(12) Patent Application Publication
(10) Pub. No.: US 2017/0109462 A1
(43) Pub. Date: Apr. 20, 2017

(54) SYSTEM AND A METHOD FOR DETERMINING APPROXIMATE SET OF VISIBLE OBJECTS IN BEAM TRACING

(71) Applicant: AKADEMIA GORNICZO-HUTNICZA IM. STANISLAWA STASZICA W KRAKOWIE, Krakow (PL)

(72) Inventors: Szymon PALKA, Kroscienko (PL); Tomasz Pedzimaz, Krakow (PL); Bartosz Ziolko, Krakow (PL)

(21) Appl. No.: 15/347,811

(22) Filed: Nov. 10, 2016

Related U.S. Application Data
(63) Continuation-in-part of application No. 14/092,971, filed on Nov. 28, 2013.

(30) Foreign Application Priority Data
Nov. 27, 2013 (CA) 2835490

(51) Int. Cl. G06F 17/50; G01H 17/00; G06F 17/17

(52) U.S. Cl. CPC G06F 17/5009; G06F 17/17; G01H 17/00; G06T 15/06

(57) ABSTRACT

A computer-implemented method for acoustic beam tracing in a three dimensional space, wherein a set of beams is a representation of a physical wave phenomenon. The method comprises receiving information regarding a beam and objects potentially intersecting the beam; executing beam-triangle intersection tests; dividing the beam into partial beams; executing beam-triangle intersection tests, with respect to the partial beams; dividing the partial beams into smaller partial beams; approximating the smaller partial beams with rays; creating delimited smaller partial beams; and applying merging of the delimited smaller partial beams.

### TECHNICAL FIELD

Embodiments of the invention generally relate to the field of beam tracing, in particular to sound tracing and thus simulating acoustic effects in real time.

### BACKGROUND

Presently, such solutions are mainly used in animated movies and/or cartoons, where calculations are time-consuming, because they do not require real-time regime. In turn, in video games industry there are usually geometry regions comprising activation triggers of various modification of sound.

A prior art Algorithm described in the literature and called Adaptive Frustum http://gamma.cs.unc.edu/SOUND/data/vis2008.pdf: (AD-Frustum: Adaptive Frustum Tracing for Interactive Sound Propagation; Anish Chandak, Christian Lauterbach, Micah Taylor, Zhimin Ren, Dinesh Manocha, Member, IEEE) also http://hal.inria.fr/docs/00/50/99/81/PDF/CG98.pdf (A Beam Tracing Method with Precise Antialiasing for Polyhedral Scenes; Djamchid GHAZANFARPOUR and Jean-Marc HASENFRATZ; Laboratoire MSI—Université de Limoges) use an adaptive beam subdivision for detecting polyhedra. In theory these methods allow to quickly find objects limiting (objects in range of the beam, not obstructed by others) the beam but in practice the structures used in the algorithm are too expensive (their usage is too time consuming) for its use in real-time solutions. Expensive intersection tests comprising specific cases, tree structures and a limited accuracy and slow beam merging algorithm does not allow to take full advantage of modern processors. The same problems make the algorithm difficult to implement and reduce its extension possibilities.

Another prior art publication U.S. Pat. No. 8,139,780 B2 entitled “Using ray tracing for real time audio synthesis” discloses a sound engine may determine a final sound at a listener location by emulating sound waves within a three-dimensional scene. The sound engine may emulate sound waves by issuing rays from a location of a sound event and tracing the rays through the three-dimensional scene. The rays may intersect objects within the three-dimensional scene which have sound modification factors. The sound modification factors and other factors (e.g., distance traveled by the ray, angle of intersection with the object, etc.) may be applied to the sound event to determine a final sound which is heard by the listener.

Another prior art publication entitled “Interactive Sound Rendering in Complex and Dynamic Scenes using Frustum Tracing” by Christian Lauterbach, Anish Chandak, and Dinesh Manocha, published in IEEE TRANSACTIONS ON VISUALIZATION AND COMPUTER GRAPHICS, VOL. 13, NO. 6, NOVEMBER/DECEMBER 2007 discloses an approach for real-time sound rendering in complex, virtual scenes with dynamic sources and objects. The approach combines the efficiency of interactive ray tracing with the accuracy of tracing a volumetric representation. There is used a four-sided convex frustum and perform clipping and intersection tests using ray packet tracing. A simple and efficient formulation is used to compute secondary frusta and perform hierarchical traversal. However the algorithm cannot perform real-time simulation and rendering on a high-end PC. This method has proven so complex that it is impossible to be executed in real time, in games on current hardware solutions.

The aim of the present invention is a computer implemented method for determining visibility in beam tracing that would be more efficient in terms of computing resources and lead to decreased time of obtaining the required results and thus enable creating real-time soundtracer.

### SUMMARY

There is disclosed a computer-implemented method for acoustic beam tracing in a three dimensional space, wherein a set of beams is a representation of a physical wave phenomenon, the method comprising the steps of:
a) receiving information regarding a beam and objects potentially intersecting the beam, wherein information regarding potentially intersecting objects is input as a representation of a scene composed of objects;
b) executing beam-triangle intersection tests, with respect to the beam and the objects to discard, and discarding the objects which do not intersect the beam
c) dividing the beam into partial beams;
d) executing beam-triangle intersection tests, with respect to the partial beams and the objects and discarding the objects which do not intersect the partial beams;
e) dividing the partial beams into smaller partial beams;
f) approximating the smaller partial beams with rays, wherein the ray approximating the smaller partial beam has a beginning at the same point as a beginning of that smaller partial beam;
g) for each ray, finding a closest object by checking all the objects intersecting with the smaller partial beam which is approximated with that ray in step (f) and selecting the object which is located closest to the beginning of the ray as the closest object;
h) creating delimited smaller partial beams by delimiting the smaller partial beams with the closest object for the ray approximating that smaller partial beam;
i) applying merging of the delimited smaller partial beams.

The representation of a scene can be a scene tree.

The method may further comprise providing data for parallel processing partial beams and respective objects in relation to the partial beams.

The object located closest to the beginning of a ray approximating this particular smaller partial beam can be determined based on a ray-triangle intersection test.

The ray-triangle intersection test can be the Ingo Wald's test.

The ray-triangle intersection tests can be executed in parallel with a use of SSE or AVX instructions.

The merging of smaller partial beams can be executed for smaller partial beams delimited by matching objects.

The matching objects can be the same object or two different objects located on the same plane and having the same material.

The set of beams can be a representation of a sound wave.

The beams may originate from a volumetric source.

The beams may originate from a directional source.

The method may further comprise creating groups of smaller partial beam parts delimited by compatible limiting surfaces.

There is also disclosed a system for acoustic beam tracing in a three dimensional space, wherein a set of beams is a representation of a physical wave phenomenon, the system comprising: a hierarchical model memory for storing a scene representation; a dedicated signal processor for performing intersection tests of ray-triangle and beam-triangle type; and a controller, coupled via a bus to the processor, configured to execute the steps of:
a) receiving information regarding a beam and objects potentially intersecting the beam, wherein information regarding potentially intersecting objects is input as a representation of a scene composed of objects;
b) executing beam-triangle intersection tests, with respect to the beam and the objects, and discarding the objects which do not intersect the beam;
c) dividing the beam into partial beams;
d) executing beam-triangle intersection tests, with respect to the partial beams and the objects and discarding the objects which do not intersect the partial beams;
e) dividing the partial beams into smaller partial beams;
f) approximating the smaller partial beams with rays, wherein the ray approximating the smaller partial beam has a beginning at the same point as a beginning of that smaller partial beam;
g) for each ray, finding a closest object, by checking all the objects intersecting with the smaller partial beam which is approximated with that ray in step (f) and selecting the object which is located closest to the beginning of the ray as the closest object;
h) creating delimited smaller partial beams by delimiting the smaller partial beams with the closest object for the ray approximating that smaller partial beam;
i) applying merging of the delimited smaller partial beams.

### BRIEF DESCRIPTION OF FIGURES

The object of the invention has been presented in an exemplary embodiment in a drawing, in which:

FIG. 1 presents a set of four cases depicting usage of a ray—triangle approach;

FIG. 2 shows division of a beam into a predefined number of sections and approximation of each of these sections with a separate ray;

FIG. 3 presents the process of Adaptive Ray-Frustum;

FIGS. 4A-4I present the method according to the present invention on an exemplary scene; and

FIG. 5 presents a block diagram of a system according to the present invention.

### NOTATION AND NOMENCLATURE

Some portions of the detailed description which follows are presented in terms of data processing procedures, steps or other symbolic representations of operations on data bits that can be performed on computer memory. Therefore, a computer executes such logical steps thus requiring physical manipulations of physical quantities.

Usually these quantities take the form of electrical or magnetic signals capable of being stored, transferred, combined, compared, and otherwise manipulated in a computer system. For reasons of common usage, these signals are referred to as bits, packets, messages, values, elements, symbols, characters, terms, numbers, or the like.

Additionally, all of these and similar terms are to be associated with the appropriate physical quantities and are merely convenient labels applied to these quantities. Terms such as “processing” or “creating” or “transferring” or “executing” or “determining” or “detecting” or “obtaining” or “selecting” or “calculating” or “generating” or the like, refer to the action and processes of a computer system that manipulates and transforms data represented as physical (electronic) quantities within the computer's registers and memories into other data similarly represented as physical quantities within the memories or registers or other such information storage.

A beam is considered herein to be a three dimensional object having a base that is a polygon (frequently located on a plane), having a defined range and edge vectors originating from vertices of the base (all such vectors should be directed at one half plane).

If extension of the edge vectors intersects at a certain point this point is called an apex. For example in case of a beam having a quadrangle base, two of the four vectors may intersect at one point and the other two in a second point. In such a case the beam virtually starts at the edge.

The most suitable bases are a triangle and a quadrangle, however, the present method may be applied to any polygon. A beam having a quadrangle base is frequently called a frustum.

The objects in 3D image processing are approximated with triangles for the mathematical operations to be easier to perform when using dedicated microprocessors. The present invention is a new method called Adaptive Ray-Frustum created after iterative attempts to extend the Adaptive Frustum algorithm and testing how this extensions impact performance.

### DETAILED DESCRIPTION

The method is based on an observation that it is advantageous to replace the small number of complex tests with an increased number of much simpler tests. In practice, most of the quadtree structure used to manage beam subdivision in the Adaptive Frustum algorithm reaches the maximum level of subdivision after addition of a low number of triangles. It turns out, that in many cases the number of simple tests used in Adaptive Ray-Frustum can be lower than the number of complex tests in Adaptive Frustum.

The method according to the present invention is based on an assumption that a sufficiently small beam can be approximated with a ray. For example, as mentioned earlier, objects in a scene used for the simulation of sound are much less complex than the corresponding graphic objects in scenes. This means that when a beam of a small size is approximated with a ray, the likelihood of an error is low. In addition, most of the beams are fully obstructed or not obstructed at all.

If it is assumed that a triangle tested for intersecting with a beam is sufficiently large that it is necessary to execute intersection tests with every part of the beam (after k-th division of the beam, the number of its parts is 4^{k}), there will be executed 4^{k+1}−1 tests.

The present invention introduces execution of up to 4^{k} simpler tests and 4^{P}−1 complex beam-triangle tests. An appropriate selection of p and k parameters allows for significant increase of processing speed and thereby significantly reduces execution time.

Approximation of a Beam with Rays

Subdivision of a beam into parts is performed to allow binary determination whether a triangle intersects with appropriately small part of the beam or not. When an intersection occurs, it is assumed that a part of the triangle intersecting the beam, fully obstructs it. Indeed, this is true only for a very small beams.

Since it is decided to use such a simplification, it appears unnecessary to use an expensive intersection test between the beam and the triangle. This expensive test can be replaced with a much simpler check whether a ray routed through the center of the beam intersects with the triangle.

On the other hand, for large beams the approximation with a ray may introduce a high error and lead to a rejection of relevant triangles. The following description discusses the individual components of the solution.

The difference between a large and a small beam lies in its appropriate division taking into account a given scene. A division allowing to detect many triangles achieves a small beam while a division which does not allow to detect many objects in a scene results in a large beam. This is a quantitative approach. For example assuming there is a one point source of sound and 6 beams are emitted from the source, each originating at a different wall of a hexagon defined on the source.

In a different example, a volumetric source may emit a certain number of beams, one for each of the walls of the 3-dimensional source representation. A directional source might emit beams only in the directions, in which the source emits sound. The beams may also be emitted from the position of the receiver, to perform a search for reachable sound sources and thus reverse the approach mentioned earlier, where sources emit beams and the routes to the receiver are created.

If the beams are not split into partial beams, for each there may be detected 1 wall, which means that the sound may reflect from at most 6 different walls. If each beam is divided one time, there will be 24 partial beams which implies that the number of objects the sound may reflect off is at most 24. In case of two times division, there are up to 96 detected objects and in case of three times division there are up to 384 objects, while in case of four times division, there are up to 1536 objects detected.

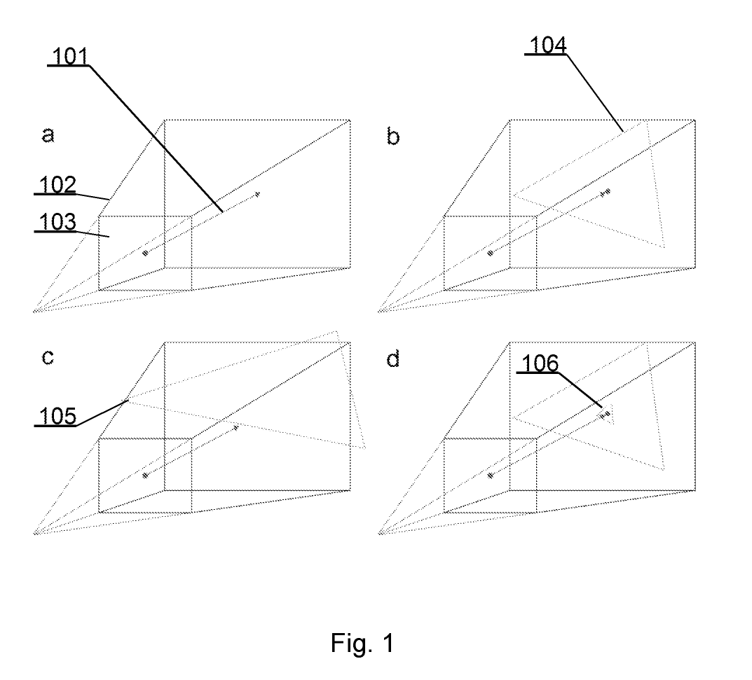

Therefore referring to a large beam means a beam insufficiently divided with respect to the scene, that is not capable of detecting numerous objects (triangles). This problem is partially depicted in FIG. 1C, where a large triangle is not detected at all because the beam has not been divided and the ray has missed the triangle. As shown in FIG. 1D the smaller triangle obstructs the large triangle and because the division of the beam is insufficient (large beam) it will not detect the large triangle.

The above descriptive definition may also be quantitatively defined with an equation i.e. the method does not detect objects smaller than (2̂(p−1))/h, wherein h is a distance to a given object and p is the number of divisions. For example: in case of a four times division and objects 10 meters away, the resolution of the method is 1.25 meter and only object larger than this number will certainly be detected. Smaller objects have only a certain probability of detection but there will never be a certainty.

### Use of Ray-Triangle Intersection Test in Adaptive Frustum

Adaptive Frustum algorithm performance tests show that its computationally most expensive part is the intersections tests. Such a test is executed frequently and each of its executions require not only a lot of calculations, but also loading into a memory information about given sub-beam.

The ideal way to speed up the intersection algorithm is to eliminate the need for mentioned test execution. However, it is not possible for all the triangles. Simplifying the intersection test can thus significantly speed up the processing of beams. A further improvement is to replace the “beam—triangle” intersection test with a “ray—triangle”.

Unfortunately, the beam approximation with a ray is inaccurate for large beams. In this case, as potentially limiting, there would be taken into consideration only the objects intersecting with the ray passing through the center of the beam. This approach is flawed for large beams. The use of such a simplified test for large beams in conjunction with proper level of beam subdivision significantly reduces the accuracy of the algorithm.

FIG. 1 presents a set of four cases depicting use of a ray—triangle approach. Case (a) presents a ray (101), approximating a beam (102), which starts at the beam's starting plane (103).

Case (b) presents a ray intersecting with a triangle (104). The triangle (104) is thereby classified as intersecting with the beam.

Case (c) presents a large triangle (105) that intersects with the beam but the ray (101) approximating the beam does not intersect with the triangle (105). As a result, the triangle (105) is erroneously classified as not intersecting with the beam.

Case (d) presents two triangles (104, 106) intersecting with the beam (102). The approximating ray (101) intersects with both triangles, whereas the smaller triangle (106) is closer to the beginning of the ray. The smaller triangle (106) is classified as covering the whole plane of the beam (102) although the larger triangle (104) is a better candidate.

### An Algorithm Using a Grid of Rays

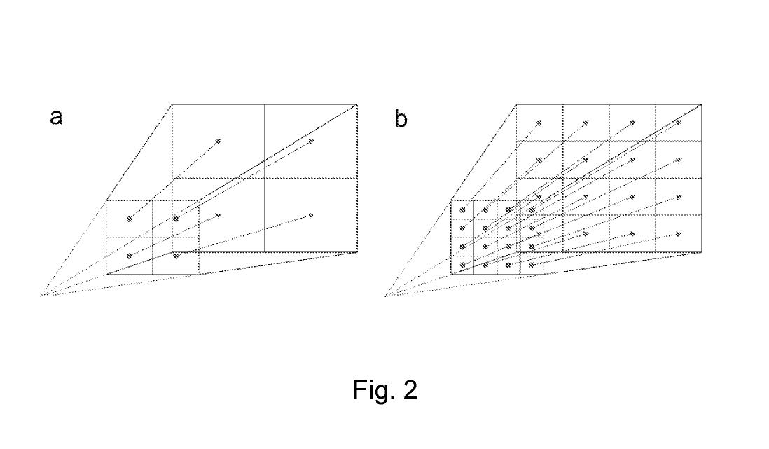

A solution of the problem of large beams approximation with a ray is a uniform division of the beam into a predefined number of sections and approximation of each of these sections with a separate ray as shown in FIG. 2.

FIG. 2 shows, as case (a), a possible approximation of a beam with four rays. This approach allows for four times higher accuracy. It means that without division there could be one triangle detected of those that intersect with the beam. Division into four partial beams allows to detect four triangles. Further division will increase accuracy but also increase the computational effort.

A test of four rays can be effectively accelerated with a use of SSE (Streaming SIMD Extensions) instructions. Case (b) shows an approximation of a beam with sixteen rays, equivalent to a threefold division of the beam.

Additionally, AVX (Advanced Vector Extensions) instructions use make it feasible to execute the intersection test of all the rays with a given triangle with two test runs (instead of sixteen runs without the vector instructions), which gives further (in the range of 3-4 times depending on instructions used and number of accesses to memory etc.) increase of speed.

Using the SSE allows to test intersection of sixteen rays with a triangle in four runs, giving up to four times increase of speed. AVX differs from the SSE mainly in that AVX executes two times more computations during data processing.

After creating a grid of rays, for each of the rays a triangle must be found, for which the distance along the direction vector from the beginning of the ray to the plane of the triangle is minimal.

It is assumed that this is the triangle that limits the beam's section that is processed. In order to reduce the number of beams created by reflection from delimiting objects, there is introduced an additional step of merging parts of the beam limited by matching triangles (a compatible triangle is the same triangle or two different triangles located on the same plane and having the same material, or triangles located in planes having similar normal and plane constant and having acoustic material of similar characteristics.

In this approach, the adaptability of the algorithm during the step of finding limiting triangles is, effectively pushed to the final stage of the process.

The solution described above is much simpler than the one proposed in Adaptive Frustum algorithm. It does not require the use of tree structures, eliminates up to half of the retained beam parts and significantly reduces the size of the data needed for description of the beam part.

In practice, if for each ray method has found the closest triangle (by scanning all the triangles and executing the intersection test with the ray), it is possible to significantly reduce memory usage in this part of the algorithm.

The problem of the approach described herein is a large number of tested ray-triangle intersections. The number of triangles potentially intersecting with the beam is large, however, most of these triangles ultimately prove not to limit the beam. Nevertheless, for small values of maximum beam subdivision, the presented approach is more efficient than the approach based on Adaptive Frustum.

### A Solution Combining Beam-Triangle and Ray-Triangle Tests

Algorithms operating directly on beams and operating only on rays, have major weaknesses. The first of them is constrained by the requirement for costly tests, but the hierarchical processing allows fast rejection of triangles. The second algorithm allows for much faster processing of a single triangle, but the number of verified triangles is too high.

The solution to this problem is to combine the advantages of both algorithms. The “beam-triangle” intersection tests are well suited for large beams, and therefore a quick and inaccurate test for coarse rejection of triangles that certainly do not intersect with the beam can be used to improve efficiency. The number of triangles to be processed within a given scene, reduced by beam intersection test, in turn significantly reduces the number of simple “ray-triangle” intersection tests. This leads to better performance.

To perform the beam-triangle intersection test, the object is divided into triangles, to perform mathematical operation in 3D computer graphics on triangles, not on abstract objects.

Another improvement of the aforementioned method is to use p-times division of the beam with application of the “beam-triangle” test for discarding the highest number of triangles. After execution of this step, a given section of the beam is divided k-p times and the obtained sections are approximated with rays.

The practical tests have shown that the p values giving the best results range between k/4 to k/2 depending on the applied “ray-triangle” intersection test and the type of vector instructions used in the implementation. As a selection of a value between k/4 to k/2 is scene dependent it is best to execute tests of a given scene. A default value may also be applied.

### The Ingo Wald Test

The test is based on the use of pre-calculated values for calculating barycentric coordinates of a point of intersection of a ray with the plane of a triangle. This algorithm is well suited to implementation using vector instructions, where several rays are tested at the same time in terms of existence of an intersection with a single triangle.

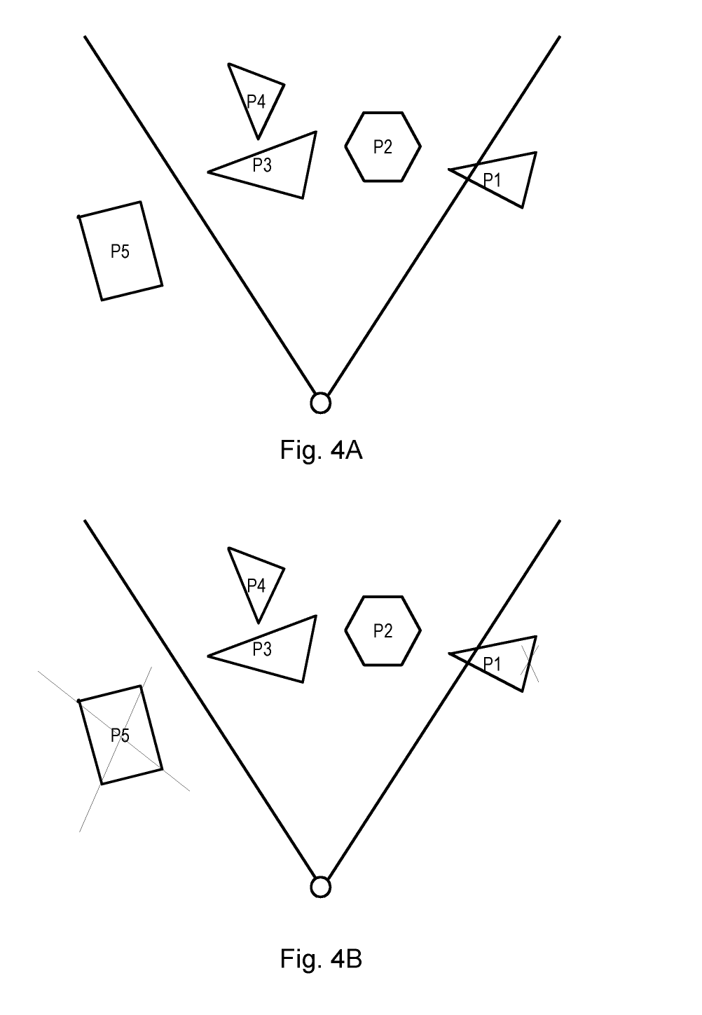

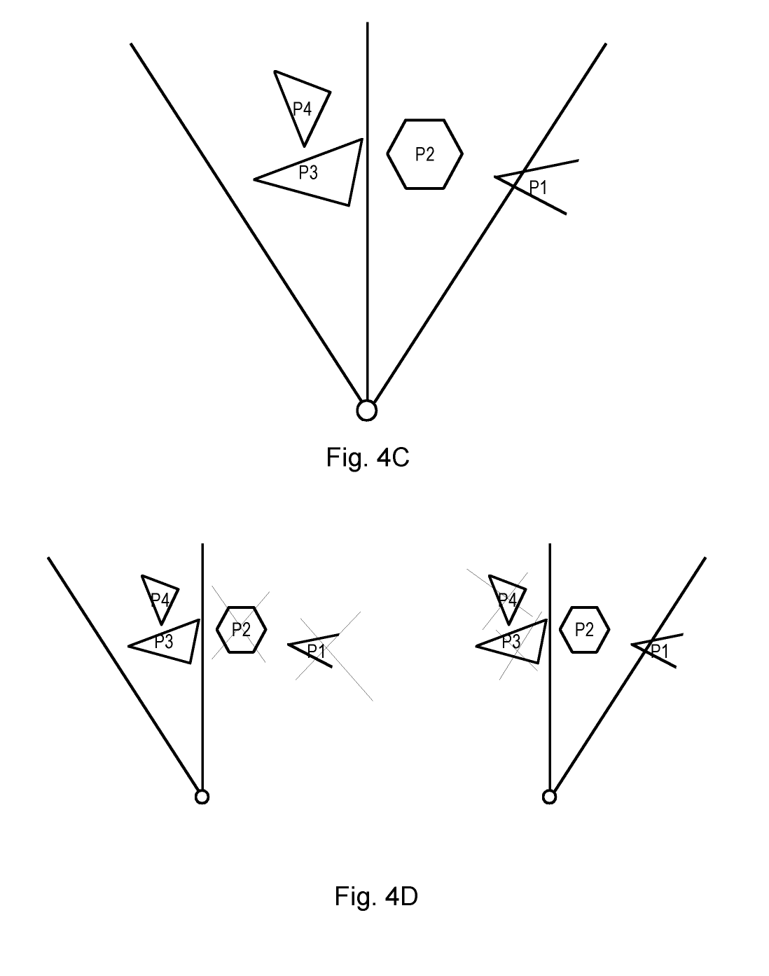

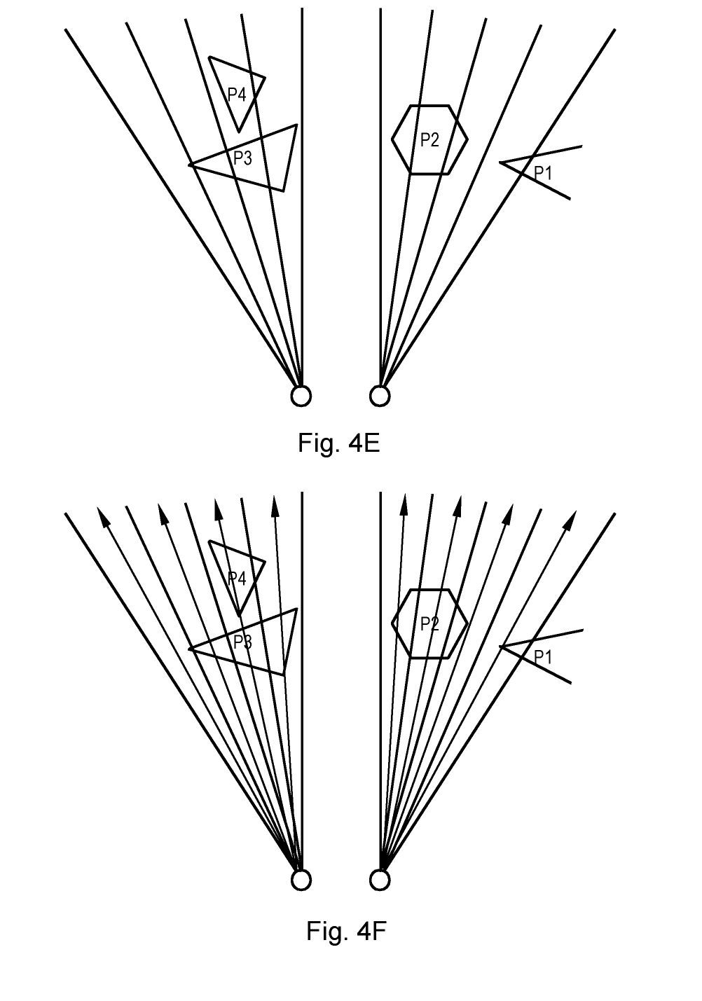

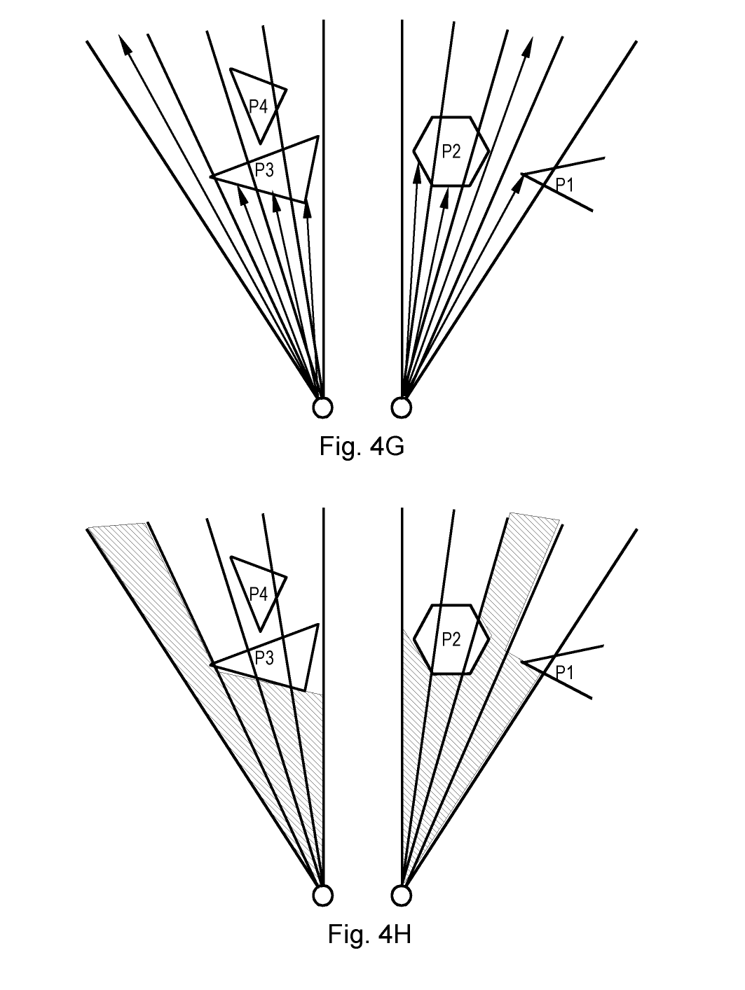

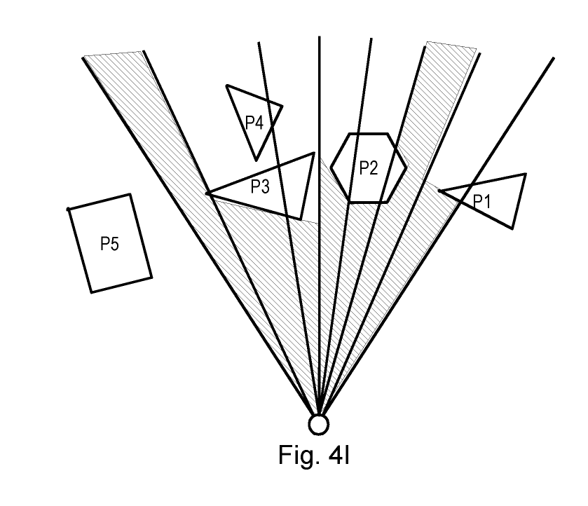

FIG. 4 presents that partial beams are approximated with a certain number of rays. Thereafter for each triangle that intersects with a given partial beam there are executed intersections with rays that approximate such partial beam. This is the moment when an intersection test, such as Ingo Wald's test, is required. This may be any intersection test such as Plucker coordinates test defined by Moller-Trumbore or other (such as
Möller Tomas i Trumbore Ben. Fast, minimum storage ray-triangle intersection. Journal of Graphics Tools 2(1). 1997, s. 21-28;
Shevtsov Maxim, Soupikov Alexei i Kapus Alexander; Ray-Triangle Intersection Algorithm for Modern CPU Architectures. Proceedings of GraphiCon '2007 conference, 2007;
Wald Ingo; Realtime Ray Tracing and Interactive Global Illumination. PhD Thesis. Saarbrucken: Max-Planck-lnstitut fur Informatik, 2004.
   There are three possible versions of the implementation of the algorithm:
an implementation that uses no vector instructions;
an implementation that uses SSE instructions—allows to perform an intersection test of four rays at one time against one triangle
an implementation that uses AVX instructions—allows to perform an intersection test of eight rays at one time against one triangle.
   Additionally, there may be implemented intersection of a plurality of triangles with one ray and acceleration of intersection of a single ray with a single triangle. Use of AVX and/or SSE and test of a plurality of rays at one time have proven most efficient on typical CPUs but other versions may be more efficient on other platforms or be easier to implement in designated hardware.

### The Adaptive Ray-Frustum Algorithm

The Adaptive Ray-Frustum Algorithm uses two levels of triangles processing in order to reduce the number of “ray-triangle” tests made in its last phase. The first level of processing is to discard these triangles, which certainly do not intersect with the beam or one of its parts. In addition, a scene tree is used to provide approximate set of triangles intersecting the beam. Such object can be defined as a hierarchical or non hierarchical structure and can provide spatial partitioning of the scene.

There is set a maximum depth of division in this part of the algorithm as p. From the list of triangles potentially intersecting with the beam there are chosen those, for which the “beam-triangle” test returns a positive result (i.e. the triangle was not classified as not intersecting the beam). Next, this list is processed in the same manner in each of the four parts of the beam. Subsequently, after p steps, the resulting list of potential triangles restricting the beam is passed to the second part of the algorithm.

The second level of processing in the Adaptive Ray-Frustum algorithm is a k-p fold division of the beam into parts and approximation of each part with a ray. For each of the triangles obtained from the first level, there is executed an intersection test with all rays approximating that part of the beam.

The state of each ray is described by a triangle, which intersects with this ray and a distance to the intersection point. If the tested triangle is closer than the recorded in the current state of the ray and the intersection test is positive, the state of the ray is updated.

The last step of the algorithm is to attempt merging of matching beams in order to reduce the number of beams stored in the algorithm.

The aforementioned method may be formulated in pseudocode as the following three methods:

```
[The Adaptive Ray-Frustum Method]
Adaptive Ray-Frustum(beam, maximum_beam_division,
pre_processing_depth, scene_tree)
{
1 Triangles = find_triangles(scene_tree)
2 If Triangles.count > 0:
{
4 grid_of_rays = Create_Grid_Of_Rays(beam)
5 Process_The_Beam(beam, maximum_beam_division,
pre_processing_depth, Triangles,
grid_of_rays)
6 Merge_partial_beams(grid_of_rays, maximum_beam_division)
}
}
[The beam processing method]
Process_The_Beam(beam, maximum_beam_division,
pre_processing_depth, Triangles_To_Process,
grid_of_rays)
{
1 For each of partial beams:
{
2 Triangles = Triangles_Intersecting_With_The_Beam(
beam_part, Triangles_To_Process)
3 If pre_processing_depth > 0:
{
4 Process_Beam(partial_beam, maximum_beam_division − 1,
pre_processing_depth − 1, Triangles, grid_of_rays)
}
5 Else:
{
6  Process_Ray_Set(partial_beam,
maximum_beam_division − 1,
                          Triangles, grid_of_rays)
}
}
}
[The method for processing a set of rays]
Process_Beams_Set(partial_beam,
maximum_beam_division − 1,
                    Triangles, grid_of_rays)
{
1 Rays_Count = maximum_beam_division * 2
2 For Each Ray Of The partial_beam:
{
3 Triangle = Closest_Triangle_Intersecting_With_The_Ray(
                          Triangles)
4 Store the Ray and the Triangle in the grid_of_rays
}
}
```

The process of finding the closest triangle may be as simple as scanning through the list of objects and selecting the one that intersects with a ray and the distance from the source of the ray to the intersection point is minimal (at this point the ray-triangle intersection test is applied).

Alternatively, one may sort the triangles according to distance of one vertex from the source plane of the beam (sometimes it allows for earlier completion of the search for the closest triangle because if one is found and is closer than the minimum distance of those yet to scan—the process may be stopped).

### The Algorithm for Beams Merging

The process of a uniform division of the beam into parts can significantly simplify merging together matching parts. Matching parts are considered parts that are adjacent and are limited by the same triangle or a triangle having the same (or similar according to a predefined measure) material and positioned in the same (or similar according to a predefined measure) plane. Sweep line algorithm is used to browse the grid of partial beams and to find areas, which, are limited by the matching triangles (matching partial beams are limited by matching triangles). Such areas are then merged in order to reduce the number of beams to be processed in the algorithm for tracking beams.

Beam merging is advantageous, because a beam is divided k times and has 4^{k} parts, which means that there will be created 4^{k} of reflected beams. Each of the reflected beams will then be divided k times into 4^{k} parts, which gives a maximum of 4^{k}*4^{k}=4² beams. For example, with an assumption that a source emits 6 beams in sound tracing engine in which only reflections are allowed, the final maximum number of beams (belonging to the same sound source) generated in the algorithm is 6*(1+4^{k}+4^{2k}+4^{4k}). For k=0 this means a maximum of 24 beams and for k=1 a maximum of 1662 beams, for k=2 a maximum of 394854 beams, for k=3 a maximum of 100688262 beams. Over 100 million beams in case of a division of each beam into 64 parts is an unacceptable number.

Limitation of the number of beams is of particular advantage at the first and the second reflection, because these beams will have to be further processed. For example in an exemplary test model there are created 1425383 beams in a conventional algorithm executed in 1.35 s while after employing of the new algorithm of beams merging, their number is reduced to 4559 and the execution time is 0.04 s.

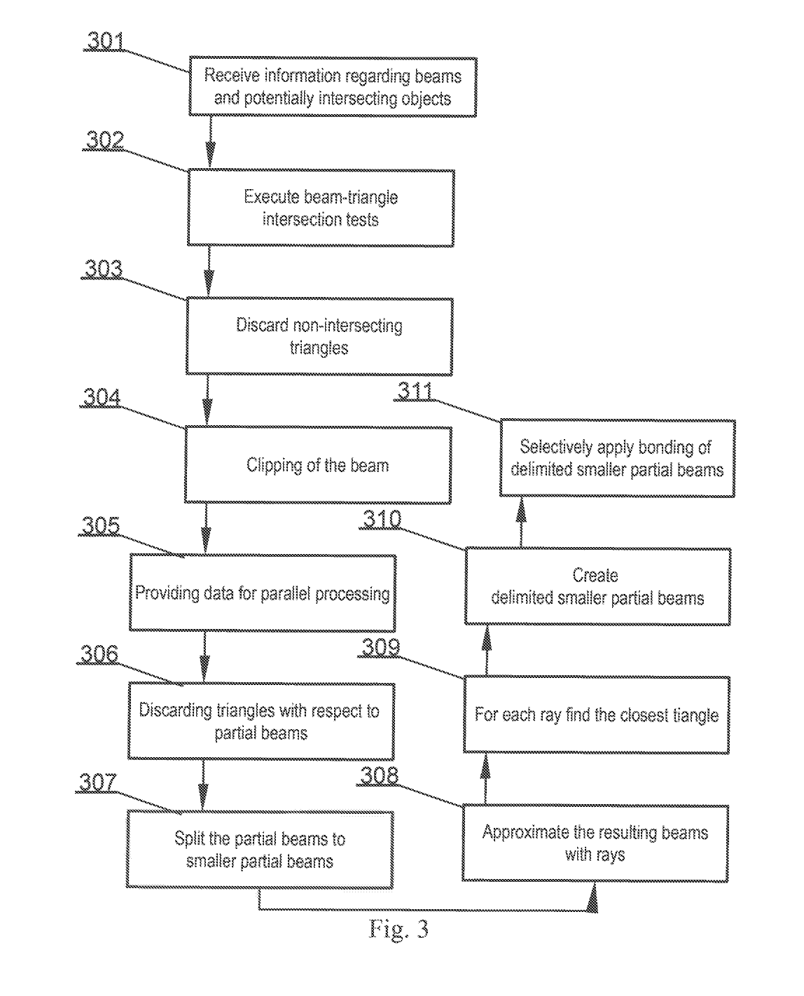

FIG. 3 presents the process of Adaptive Ray-Frustum. At step 301, there is received information regarding a sound beam and potentially intersecting objects (using a scene tree). In the Adaptive Ray-Frustum Method presented earlier in pseudocode, this step corresponds to line 1. Subsequently, at step 302 there are executed “beam-triangle” intersection tests. In the beam processing method presented earlier in pseudocode, this step corresponds to line 2. Those elements, for which an intersection test is negative are discarded at step 303.

After the first major part of the method is complete, the procedure advances at step 304 to divide the beam into partial beams. In the beam processing method presented earlier in pseudocode, this step corresponds to lines 3-4. Subsequently, at step 305, there is provided data for parallel processing—for example two partial beams and respective triangles to further processing in relation to the partial beams. In the beam processing method presented earlier in pseudocode, this step corresponds to lines 3-4.

Next, at step 306, there is executed discarding of triangles with respect to partial beams. The scene elements are verified against intersecting with the partial beams. Those for which the intersection test is negative are discarded. In the beam processing method presented earlier in pseudocode, this step corresponds to line 2.

Subsequently, at step 307, the partial beams are divided into smaller partial beams. In the method for processing a set of rays presented earlier in pseudocode, this step corresponds to line 1. Thereafter, at step 308, the partial beams of step 307 are approximated with rays. In the method for processing a set of rays presented earlier in pseudocode, this step corresponds to line 2. Next, at step 309, for each ray there is found the closest triangle if such a triangle exists. In the method for processing a set of rays presented earlier in pseudocode, this step corresponds to line 3. Thereafter, at step 310, there are created delimited smaller partial beams. Each ray from the previous step corresponds to a single partial beam. The smaller partial beam is delimited by an object, which is located closest to the beginning of a ray approximating this particular partial beam of step 307. In the method for processing a set of rays presented earlier in pseudocode, this step corresponds to line 4.

The final step of the method 311 is to selectively apply merging of smaller partial beams previously delimited. This step is executed in order to limit the result of the processing. In the Adaptive Ray-Frustum Method presented earlier in pseudocode, this step corresponds to line 6.

FIGS. 4A-4I present the method according to the present invention on an exemplary scene. The scene comprises a single beam and five obstacles P1-P5 as shown in FIG. 4A also comprising one beam. FIG. 4B presents a result of executing method steps 302, 303 that is the whole P5 and part of P1 objects are discarded as non-intersecting with the main, initial beam. FIG. 4C presents the result of step 304 of the method wherein in this example the beam is divided into two partial beams. FIG. 4D presents the result of step 305 and 306 of the method. Data for parallel processing of the left partial beam and the right partial beam are provided and objects are discarded with respect to the previously defined partial beams.

FIG. 4E presents further division of the left partial beam and the right partial beam in line with the step 307 of the method. FIG. 4F presents step 308 of the method where partial beams are approximated with rays. FIG. 4G presents step 309 of the method where the closest triangles are found for respective beams. FIG. 4H presents step 310 of the method and the resulting delimited smaller partial beams (not rays as at this stage the processing of partial beams is resumed).

Finally, FIG. 4I presents the final result of step 311 with smaller partial beam merging applied. In this case it was possible to merge two smaller partial beams delimited by the P3 object. Merging of partial beams of P2 was not possible because the walls of the P2 object delimiting the partial beams are located in different planes.

A comparison of the result of the method with an ideal result allows to determine that an appropriate selection of coefficients allows for obtaining an acceptable approximations of a precise result. The phase of merging partial beams allows in this case to decrease the number of final partial beams from 8 to 7. In practice there are frequently situations, in which the number of final beams decreases multiple times after the use of merging algorithm.

All the examples of FIG. 4 have been depicted in a two dimensional case. The objects shown are pillars in the three dimensional space (a front view instead of top view as in FIG. 4. Each edge of a perspective view of the pillar is in 3D represented by two triangles.

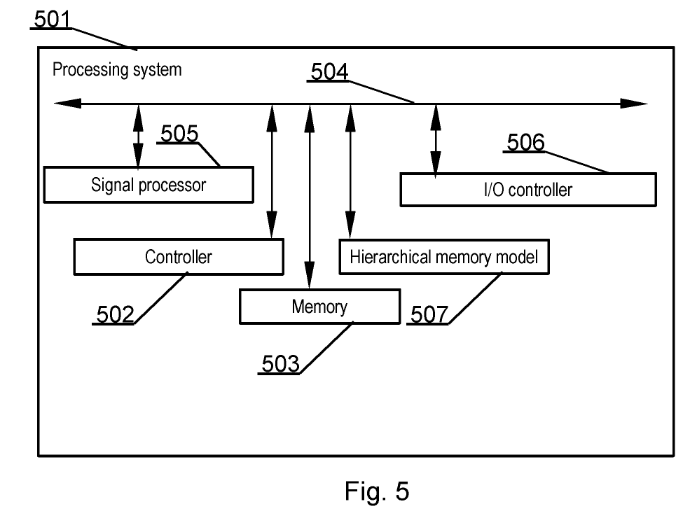

FIG. 5 presents a block diagram of a system according to the present invention. The system 501 according to the present invention may be also built as a dedicated hardware module, which will perform analogous role to existing GPU units. Such a module may be split into two core parts: a hierarchical model memory 507 for storing a beam and a scene tree and a dedicated signal processor 505 for performing intersection tests (both: ray-triangle and beam-triangle). The module can also be a part of hardware performing real-time sound tracing, which by using a scene representation, sources and receiver positions could render sound in a similar way to which GPU (Graphics Processing Unit) is used to render graphics.

Additionally there is a general purpose controller 502, for executing the steps of the aforementioned method for sound tracing in cooperation with an I/O controller 506, a memory 503.

The inner circuits will consist of hardware implementation of the aforementioned algorithms. In order to perform transformation from software to hardware one can use existing industry standard solutions like VHDL language.

The invention may also be implemented in a form of a dedicated hardware module, preferably an extension card, that will detect objects. This dedicated hardware module may be connected with other modules to create complete beam tracing or sound rendering module.

A processor of such extension card comprises a set of multithread logical units that using vector instructions process in parallel independent sets of tests of beam-triangle intersection.

Such processor also comprises a set of multithread logical units that using vector instructions process, in parallel, independent sets of tests of ray-triangle intersection.

The extension card also comprises a dedicated dispatcher circuit for assigning sets of tests to idle logical units.

The extension card also comprises a memory having a hierarchical model for storing a scene model. The hierarchical model memory is connected via a bus to the processors. A read/write buffer may comprise rays in a form of normalized directional vectors.

A scene tree is loaded into the hierarchical model memory at an initialization stage. Software using the extension card sends to the card a set of beams, for which visible objects have to be found. In response the software receives triangles intersecting with different rays into which the beam was divided.

Such extension card may be implemented in System on Chip technology (SoC) and may be a dedicated hardware for video gaming machines or computers or for other multimedia and wave phenomena simulation purposes.

A hardware implementation increases efficiency, which is an advantage as performance in gaming environments is always a priority.

The described algorithm significantly speeds up processing in applications for tracing beams in order to simulate the propagation of sound and other applications where beam tracing can be used. The use of a hybrid combination of processing beams and processing of rays eliminates the weaknesses of the Adaptive Frustum algorithm. The resulting method for finding objects limiting the beam is much simpler to implement and allows the use of a more efficient algorithm for merging the beams. There has been gained a significant improvement in efficiency, while at the same time reducing the number of output beams.

It is a mixture of the Adaptive Frustum Tracing and Uniform Frustum Tracing with appropriate application of both of them. The first algorithm allows for quick discarding of triangles out of range and the other uses simple tests. The present solution allows for execution of some complex discarding tests and then execute as a set of quick simple tests on rays.

The present method due to multi-pass structure first extracts, from the scene tree, cells intersecting with the beam and from these cells extracts triangles subsequently passed to a discarding and beam division algorithm executed for a given time in order to finally approximate partial beams with rays and the remaining triangles are intersected with these rays. In case there is a need to do so, subsequent phases may be combined, for example extracting cells from the scene tree and obtaining triangles from them.

A different embodiment of the present invention may instead of emitting from the source/emitter beams in all directions, emit a predefined number of rays and perform reflections from full triangles (one time for each triangle):
First, rays are emitted in all directions and there are found triangles with which they intersect; and
Secondly, There are created reflected beams for all such triangles and subsequently typical processing is applied.

### Merging of Beams Delimited by Compatible Limiting Surfaces

It is highly probable, that multiple smaller partial beams are delimited by a compatible limiting surface (i.e. the same triangle or different triangles that are nearly coplanar and have assigned similar acoustic materials), In such a case it is advantageous to reflect these smaller partial beams collectively and thus reduce the overall number of beams processed. To achieve that, a step of merging appropriate smaller partial beams can be introduced to the method defined above.

The simplest merging algorithm is one that does not merge any beams (i.e. its output is the same as its input).

In one embodiment, the smaller partial beams can be merged using an algorithm based on a quadtree. This technique of frustum merging known from Lauterbach (Interactive Sound Rendering in Complex and Dynamic Scenes using Frustum Tracing; Christian Lauterbach, Anish Chandak, and Dinesh Manocha, published in IEEE TRANSACTIONS ON VISUALIZATION AND COMPUTER GRAPHICS, VOL. 13, NO. 6, NOVEMBER/DECEMBER 2007) and Chandak (AD-Frustum: Adaptive Frustum Tracing for Interactive Sound Propagation; Anish Chandak, Christian Lauterbach, Micah Taylor, Zhimin Ren, Dinesh Manocha, Member, IEEE). It starts at the whole beam and investigates the beam parts. In case any of four parts are subdivided, the algorithm is firstly applied to these parts. If none of the parts are subdivided or recursive call on the subdivided parts has been completed successfully, the algorithm attempts to combine the beam parts. If all four parts are delimited by compatible limiting surfaces, they are combined into one beam. Otherwise, the four beam parts are processed separately (e.g. reflected, diffracted, transmitted) and a failure result is returned.

In another embodiment, the smaller partial beams can be merged using an algorithm based on a sweep line, e.g. such as described by Shamos, Michael I.; Hoey, Dan (1976), “Geometric intersection problems”, Proc. 17th IEEE Symp. Foundations of Computer Science (FOCS '76), pp. 208-215. This algorithm firstly assigns two dimensional coordinates to each of the beam parts, such that two neighbouring beams (i.e. beams sharing a polygonal wall) will have consecutive x or y coordinates, depending on which wall is shared by them. The merging starts at a beam with (x,y)=(0,0) coordinates, grouping beams delimited by compatible limiting surfaces, with fixed x and growing y coordinates. Then, the group expansion step follows.

For example, assume that a group G1 starts at (xs. ys) coordinates, ends at (xs. ye) and is delimited by the surface T. Group G2 can be merged with G1 if and only if it starts at (xs+1. ys), ends at (xs+1. ye), and is delimited by a surface compatible with T. After G1 and G2 are merged, they can be merged with group G3 if and only if it is at (xs+2. ys), ends at (xs+2. ye) and is delimited by a surface compatible with T. The group expansion is performed until there is no two groups that could be merged. In the end, each group is processed separately (e.g. reflected, diffracted, transmitted), as one beam.

In another embodiment, the smaller partial beams can be merged using an algorithm based on approximates, that attempts to lower the number of merged beams at the cost of decreased accuracy. This algorithm creates a lower number of merged beams at the expense of decreased accuracy. It extends the algorithm based on the sweep line technique, by taking slopes into account. For example, assume that a group G1 starts at (xs. ys1) coordinates, ends at (xs. ye1) and is delimited by the surface T. Group G2 starts at (xs+1. ys2) coordinates, ends at (xs+1. ye2) and is delimited by a surface compatible with T. G1 and G2 can be merged if and only if the intervals [ys1,ye1] and [ys2,ye2] overlap. After merging of two previously unmerged groups, the algorithm computes slopes as follows:

s_{s}=sign(ys2−ys1)

s_{e}=sign(ye2−ye1)

After G1 and G2 are merged, they can be merged with G3 if and only starts at (xs+2. ys3), ends at (xs+2. ye3), is delimited by a surface compatible with T, the intervals [ys2,ye2] and [ys3,ye3]

It can be easily recognized, by one skilled in the art, that the aforementioned method for sound tracing may be performed and/or controlled by one or more computer programs. Such computer programs are typically executed by utilizing the computing resources in a computing device such as personal computers, personal digital assistants, cellular telephones, receivers and decoders of digital television or the like. Applications are stored on a non-transitory medium. An example of a non-transitory medium is a non-volatile memory, for example a flash memory or volatile memory, for example RAM. The computer instructions and are executed by a processor. These memories are exemplary recording media for storing computer programs comprising computer-executable instructions performing all the steps of the computer-implemented method according the technical concept presented herein.

While the invention presented herein has been depicted, described, and has been defined with reference to particular preferred embodiments, such references and examples of implementation in the foregoing specification do not imply any limitation on the invention. It will, however, be evident that various modifications and changes may be made thereto without departing from the broader scope of the technical concept. The presented preferred embodiments are exemplary only, and are not exhaustive of the scope of the technical concept presented herein.

It can be easily recognized, by one skilled in the art, that the aforementioned method for beam tracing, in particular sound tracing, may be performed for simulating other physical wave phenomena like light, radio waves or shock waves. As a result the method can be used in multimedia and simulation systems other than sound tracer.

Accordingly, the scope of protection is not limited to the preferred embodiments described in the specification, but is only limited by the claims that follow.

We claim:

1. A computer-implemented method for acoustic beam tracing in a three dimensional space, wherein a set of beams is a representation of a physical wave phenomenon, the method comprising the steps of:
a) receiving information regarding a beam and objects potentially intersecting the beam, wherein information regarding potentially intersecting objects is input as a representation of a scene composed of objects;
b) executing beam-triangle intersection tests, with respect to the beam and the objects to discard, and discarding the objects which do not intersect the beam
c) dividing the beam into partial beams;
d) executing beam-triangle intersection tests, with respect to the partial beams and the objects and discarding the objects which do not intersect the partial beams;
e) dividing the partial beams into smaller partial beams;
f) approximating the smaller partial beams with rays, wherein the ray approximating the smaller partial beam has a beginning at the same point as a beginning of that smaller partial beam;
g) for each ray, finding a closest object by checking all the objects intersecting with the smaller partial beam which is approximated with that ray in step (f) and selecting the object which is located closest to the beginning of the ray as the closest object;
h) creating delimited smaller partial beams by delimiting the smaller partial beams with the closest object for the ray approximating that smaller partial beam;
i) applying merging of the delimited smaller partial beams.

2. The method according to claim 1 wherein the representation of a scene is a scene tree.

3. The method according to claim 1 further comprising providing data for parallel processing partial beams and respective objects in relation to the partial beams.

4. The method according to claim 1 wherein the object located closest to the beginning of a ray approximating this particular smaller partial beam is determined based on a ray-triangle intersection test.

5. The method according to claim 4 wherein the ray-triangle intersection test is the Ingo Wald's test.

6. The method according to claim 4 wherein the ray-triangle intersection tests are executed in parallel with a use of SSE or AVX instructions.

7. The method according to claim 1 wherein the merging of smaller partial beams is executed for smaller partial beams delimited by matching objects.

8. The method according to claim 1 wherein the matching objects are the same object or two different objects located on the same plane and having the same material.

9. The method according to claim 1 wherein the set of beams is a representation of a sound wave.

10. The method according to claim 1, wherein the beams originate from a volumetric source.

11. The method according to claim 1, wherein the beams originate from a directional source.

12. The method according to claim 1, further comprising creating groups of smaller partial beam parts delimited by compatible limiting surfaces.

13. A system for acoustic beam tracing in a three dimensional space, wherein a set of beams is a representation of a physical wave phenomenon, the system comprising:
a hierarchical model memory for storing a scene representation;
a dedicated signal processor for performing intersection tests of ray-triangle and beam-triangle type; and
a controller, coupled via a bus to the processor, configured to execute the steps of:
a) receiving information regarding a beam and objects potentially intersecting the beam, wherein information regarding potentially intersecting objects is input as a representation of a scene composed of objects;
b) executing beam-triangle intersection tests, with respect to the beam and the objects, and discarding the objects which do not intersect the beam;
c) dividing the beam into partial beams;
d) executing beam-triangle intersection tests, with respect to the partial beams and the objects and discarding the objects which do not intersect the partial beams;
e) dividing the partial beams into smaller partial beams;
f) approximating the smaller partial beams with rays, wherein the ray approximating the smaller partial beam has a beginning at the same point as a beginning of that smaller partial beam;
g) for each ray, finding a closest object, by checking all the objects intersecting with the smaller partial beam which is approximated with that ray in step (f) and selecting the object which is located closest to the beginning of the ray as the closest object;
h) creating delimited smaller partial beams by delimiting the smaller partial beams with the closest object for the ray approximating that smaller partial beam;
i) applying merging of the delimited smaller partial beams.
